(19) United States
(12) Patent Application Publication
(10) Pub. No.: US 2024/0378046 A1
(43) Pub. Date: Nov. 14, 2024

(54) VEHICLE DEVICE

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/437,695

(22) Filed: Feb. 9, 2024

(30) Foreign Application Priority Data
May 9, 2023 (JP) 2023-077115

(51) Int. Cl. G06F 8/65

(52) U.S. Cl. CPC G06F 8/65

(57) ABSTRACT

OTA master mounted on the vehicle is configured as an in-vehicle device that manages updating of the software of the vehicle. The OTA master determines whether user consent is necessary based on the type of software. Then, when determining that user consent is necessary, the OTA master makes an inquiry to the user as to whether to execute a process for the update of the software.

### CROSS-REFERENCE TO RELATED APPLICATION

This application claims priority to Japanese Patent Application No. 2023-077115 filed on May 9, 2023, incorporated herein by reference in its entirety.

### BACKGROUND

### 1. Technical Field

The present disclosure relates to in-vehicle devices that are mounted on vehicles.

### 2. Description of Related Art

Japanese Unexamined Patent Application Publication No. 2021-105923 (JP 2021-105923 A) describes an in-vehicle device that manages software updates for a vehicle. When performing a software update, the in-vehicle device makes an inquiry to a user as to whether the update is necessary and the start time of the update.

If a software update is performed frequently, the number of inquiries to the user also increases. As a result, the user may feel annoyed by such frequent inquiries.

### SUMMARY

An in-vehicle device that solves the above problem is an in-vehicle device mounted on a vehicle and configured to manage an update of software for the vehicle. The in-vehicle device includes: a determination unit configured to determine whether user consent is necessary based on a type of the software; and a control unit configured to, when the determination unit determines that the user consent is necessary, make an inquiry to a user as to whether to perform a process for the update of the software.

The in-vehicle device advantageously reduces the frequency of inquiries to the user at the time of software updates.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an in-vehicle device according to an embodiment;

FIG. 2 is a sequence diagram illustrating a flow of a software update process;

FIG. 3 is a table showing an example of setting of user approval necessity for each type of software;

FIG. 4 is a diagram illustrating an exemplary acceptance window; and

FIG. 5 is a diagram illustrating an exemplary selection window.

### DETAILED DESCRIPTION OF EMBODIMENTS

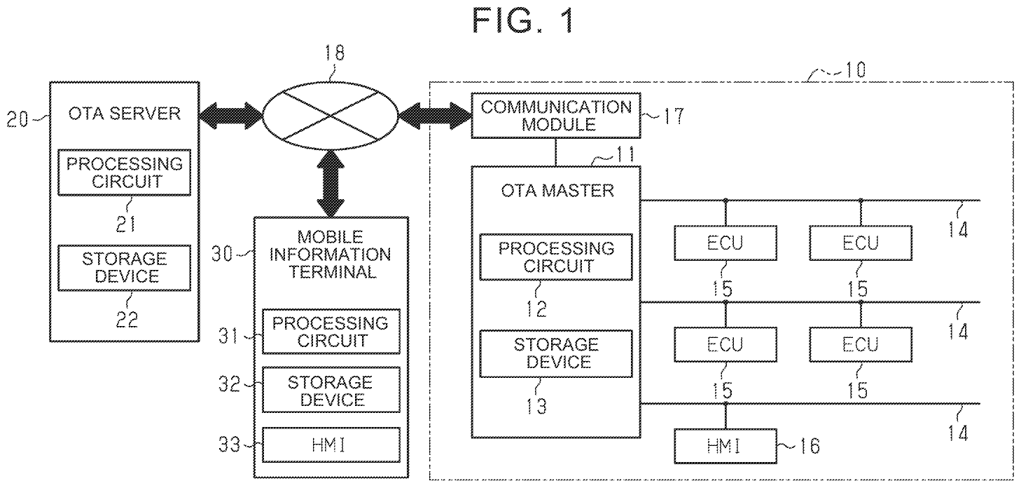

Hereinafter, an embodiment of an in-vehicle device will be described in detail with reference to FIGS. 1 to 4.

### Configuration of In-Vehicle Device

First, a configuration of an in-vehicle device according to the present embodiment will be described with reference to FIG. 1.

Various ECU (electronic control units) 15 for controlling the respective units of the vehicle 10 are mounted on the vehicle 10. Examples of ECU 15 include engine-driven ECU, transmission ECU, braking ECU, advanced driver assistance ECU, and multimedia ECU.

The vehicle 10 is also equipped with a OTA master 11, which is an in-vehicle device that manages software-updating in the vehicle 10. OTA master 11 includes a processing circuit 12 and a storage device 13. In the storage device 13, a program for managing software update is stored in advance. OTA master 11 is configured to perform processing related to managing software updating by the processing circuit 12 reading and executing a program stored in the storage device 13. In the present embodiment, OTA master 11 corresponds to an in-vehicle device that manages updating of software of the vehicle 10. OTA master 11 is connected with a radio communication module 17 for performing out-of-vehicle communication through the mobile communication network 18.

Further, the vehicles 10 are equipped with an HMI (human machine interface) 16. HMI 16 includes an input device that accepts an operation of an occupant, and an output device that presents information to the occupant by images and sounds. In the present embodiment, HMI 16 has a navigation function for guiding the traveling route and an entertainment function for playing back music/video. OTA master 11, ECU 15, and HMI 16 are configured to be able to communicate with each other via the in-vehicle networking line 14.

Software is updated in the vehicle 10 based on the update data distributed from OTA servers 20 through the mobile communication network 18 or the like. OTA servers 20 include a processing circuit 21 and a storage device 22. OTA servers 20 are configured to be capable of communicating with the outside via the mobile communication network 18.

Further, OTA master 11 and OTA servers 20 are configured to be able to communicate with the mobile terminals 30 of the users of the vehicles 10 via the mobile communication network 18 and the like. An example of the mobile terminal 30 is a smartphone. The mobile terminal 30 includes a processing circuit 31, a storage device 32, and an HMI 33. The processing circuit 31 reads and executes a program stored in the storage device 32. The program stored in the storage device 13 includes a program for vehicle management.

### Software Updates

Next, the software update of the vehicle 10 will be described. A specific software to be updated is software of in-vehicle electronic equipment such as OTA master 11 and ECU 15, HMI 16. In the following description, in-vehicle electronic equipment for which a software update is to be performed is referred to as target equipment. Software updates are made through three phases: download, install, and activate.

In the download phase, software update data is downloaded to the vehicle 10. In the download phase, OTA master 11 acquires updated data from OTA servers 20 and stores the updated data in the storage device 13. The download phase includes a series of processes related to download, such as determination of whether download is executable or not, verification of update data, and the like. The update data transmitted from OTA servers 20 to OTA master 11 may include any of update software, compressed data obtained by compressing the update software, updated software, or divided data obtained by dividing the compressed data. The update data may include an identifier of the update equipment and an identifier of the software before the update. The update data is downloaded as a distribution package. The distribution package includes update data of one or more pieces of in-vehicle electronic equipment.

In the installation phase, the update software is written to the target equipment. In the installation phase, the OTA master 11 writes the updating software into the memory of the target equipment. The installation phase includes a series of processes related to installation, such as determination of whether installation is executable, transfer of update data, verification of update software, and the like. When the update data includes the update software itself, OTA master 11 transfers the update data to the target equipment in the installation phase. When the update data includes the compressed data, the difference data, or the divided data of the update software, a process of generating the update software from the update data is performed. The generation process may be performed by the OTA master 11 or by the target equipment. The generation of the update software can be performed by decompressing the compressed data, assembling the difference data or the divided data. When the installation phase is completed, the update software is invalidated.

In the activation phase, the update program is activated on the target equipment. That is, in the activation phase, the software used for the operation of the target equipment is switched from the software before the update to the software after the update. The activation phase includes a series of processes related to activation such as determination of whether to execute activation, consistency check of an update program, verification of an execution result of activation, and the like.

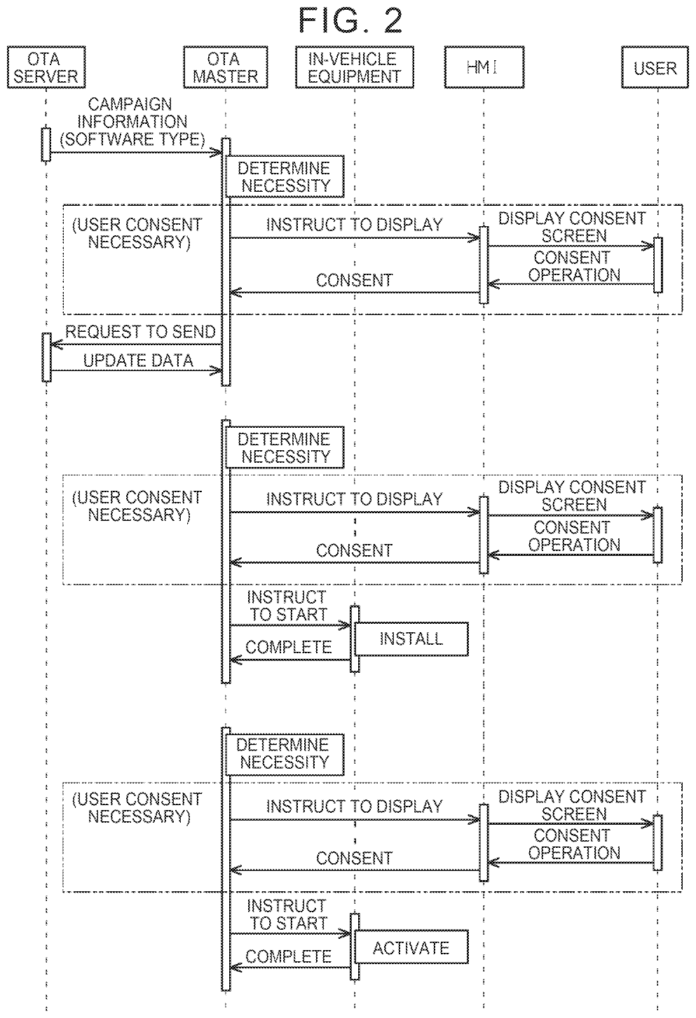

Hereinafter, the processing related to the software update will be described in detail with reference to FIG. 2 to FIG. 4. FIG. 2 illustrates a flow of processing related to software update. As illustrated in FIG. 2, when updating the software, OTA servers 20 first distribute the campaign information to the vehicles 10 to be updated. The campaign information includes information such as a vehicle type to be updated, an update content, a delivery start time of the update data, a size of the update data, and an estimated time of the update. The update software is classified into a plurality of types according to in-vehicle electronic equipment, a function, an importance level, an urgency level, and the like to which the software is applied. The campaign information also includes information on the type of the update software. OTA master 11 acquires the type of software to be updated from the campaign information.

After that, when the update data is ready to be downloaded, the OTA master 11 determines whether user consent to the download is necessary based on the type of the update software. As described above, software updates are performed through the three phases: download, install, and activate. In the in-vehicle device of the present embodiment, the necessity of user consent at the time of execution of each phase is set in advance for each type of software. The storage device 13 of OTA master 11 stores in advance a data table regarding whether user consent is necessary for each phase for each type of software. The OTA master 11 refers to such a data table and determines whether user consent is necessary.

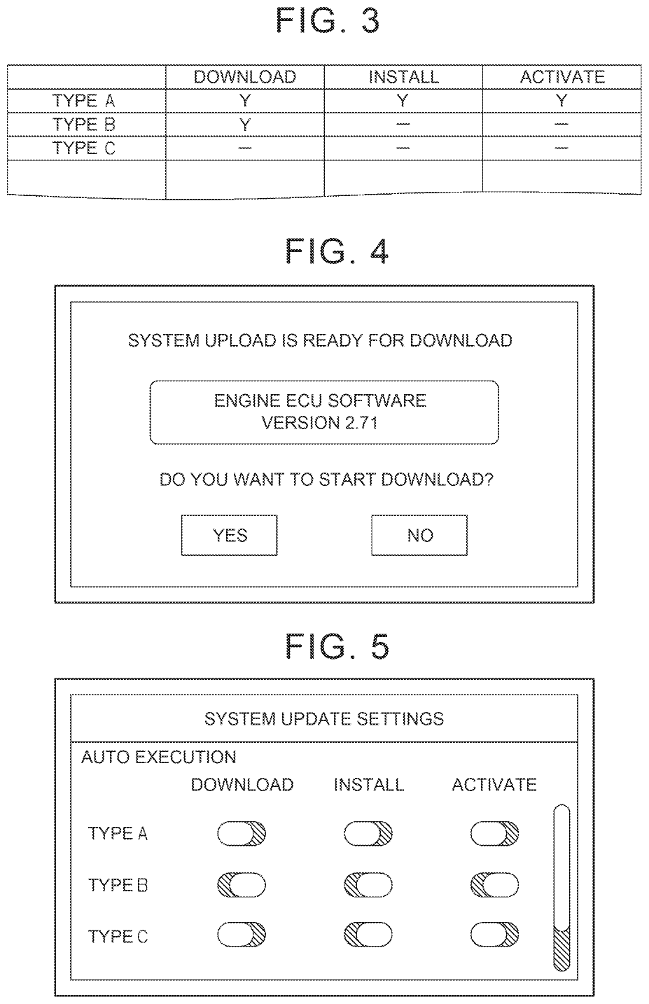

FIG. 3 shows a configuration example of such a data table. In FIG. 3, “Y” indicates that user consent is necessary, and “-” indicates that user consent is not necessary. For the software of type A, user consent is necessary for all of download, installation, and activation. For the software of type B, user consent is necessary for download, but is not necessary for installation and activation. For the software of type C, user consent is not necessary for any of download, installation, and activation.

When it is determined that user consent is not necessary for the download, the OTA master 11 automatically starts downloading the updated data. When the downloading is started, OTA master 11 requests OTA servers 20 to transmit the updated data. In response to this request, OTA servers 20 transmit the updated data to OTA master 11. OTA master 11 stores the received updated data in the storage device 13.

On the other hand, when it is determined that user consent is necessary for the download, the OTA master 11 makes an inquiry to the user to obtain consent to the download. When making an inquiry, the OTA master 11 first instructs the HMI 16 to display the consent screen. In response to this instruction, HMI 16 displays the authorization window. The consent screen is configured to allow a user to select whether to execute download of update data. In the following description, a user's operation of giving consent to the download is referred to as a consent operation. In addition, an operation of the user who selects not to grant the execution of the download is described as a rejection operation. When the user performs the authorization operation in HMI 16 where the authorization screen is displayed, HMI 16 notifies OTA master 11 that the user has authorized the downloading. In response to this notification, OTA master 11 starts downloading the updated data.

FIG. 4 shows an example of the configuration of the license screen. In the screen configuration example of FIGS. 4 and 5, the software update and the update data are referred to as “system update”. In the license screen of FIG. 4, a guide that download is possible and the type and version of the software to be updated are displayed. In addition, a button for selecting whether to give consent to the start of download is displayed on the consent screen. The authorization screen may be configured to be able to transition to a screen displaying the detailed contents of the software to be updated.

When the user performs a rejection operation on the consent screen, the download of the update data is temporarily suspended. In this case, the OTA master 11 makes an inquiry to obtain user consent when the download execution condition is satisfied. At the time of the user's rejection operation, the user may manually set the date and time at which the download is started.

When the installation becomes executable after the completion of the downloading, OTA master 11 determines whether user consent is necessary for the installation based on the type of the update data. When it is determined that user consent is not necessary, the OTA master 11 automatically starts installing the updating software on the target equipment. On the other hand, when it is determined that user consent is necessary, the OTA master 11 makes the same inquiry to obtain user consent as in the case of the download. Then, OTA master 11 waits for the user's consent to be obtained and starts installing. Specifically, the OTA master 11 instructs the target equipment to start installation. The OTA master 11 confirms that the installation has been completed with the completion notification from the target equipment.

After that, when the update software is ready to be activated, the OTA master 11 determines whether user consent is necessary for the activation based on the type of the update data. The OTA master 11 automatically starts the activation when it is determined that user consent is not necessary. On the other hand, when it is determined that user consent is necessary, the OTA master 11 makes the same inquiry to obtain user consent as in the case of the download and installation. Then, OTA master 11 waits for the user's consent to be obtained and starts the activation. Specifically, the OTA master 11 instructs the target equipment to start activation. The OTA master 11 confirms that the activation is completed by the completion notification from the target equipment.

### Operation and Effect of Embodiment

The action and effect of the present embodiment will be described. OTA master 11, which is one of the in-vehicle devices mounted on the vehicle 10, manages updating of the software of the vehicle 10. When updating the software, the OTA master 11 determines whether user consent is necessary based on the type of the software to be updated. When it is determined that user consent is necessary, the OTA master 11 makes an inquiry to the user as to whether to execute a process for the update of the software. In this embodiment, the OTA master 11 corresponds to the determination unit and the control unit.

The OTA master 11 updates the software in the vehicle 10 through the three phases: downloading the update data, installing the update program on the target equipment, and activating the update program. The OTA master 11 separately determines whether user consent is necessary for each of the three phases.

Some types of software require user consent for all of the three phases, and other types of software does not require user consent for all of the three phases. In the above embodiment, when user consent is not necessary, an inquiry to the user is omitted, and the update operation is automatically performed. Therefore, the in-vehicle device of the above embodiment advantageously reduces the frequency of inquiries to the user at the time of software updates.

### Setting of Necessity of User Consent by Software Type

As described above, in the present embodiment, whether user consent is necessary for each phase of software update is changed according to the type of software. The type of the software that makes the necessity of the user consent different may be determined in consideration of the function of the software, the urgency of the update, the time required for the update operation, and the like.

Some software updates have a deadline for completion of the update. For example, in the case of updating software addressing the revision of laws and regulations, it is necessary to complete the update by the enforcement of the laws and regulations. Further, for security or the like, an urgent update of software may be required. It is conceivable to set whether user consent is necessary in consideration of the urgency degree of the update. Software in this case is classified as high or low update urgency. OTA master 11 determines the degree of urgency from the type of the updating software. When updating highly urgent software, the OTA master 11 automatically performs the update without making an inquiry to obtain user consent. When updating less urgent software, the OTA master 11 makes an inquiry to obtain user consent and performs the update at the time desired by the user.

Some software may limit the functionality of the vehicle 10 in some or all of the phases of the software update. For example, in the case of software for controlling the travel of the vehicle 10, the travel of the vehicle 10 may be prohibited during activation. On the other hand, depending on the type and phase of the software, the update operation may be performed without restricting the function of the vehicle 10. It is conceivable to set whether user consent is necessary in consideration of the presence or absence of the function restriction at the time of the update. Software in this case is classified into one in which the function restriction occurs at the time of updating and one in which the function restriction does not occur. When the function restriction occurs, user consent is obtained and the update work is executed, while when the function restriction does not occur, whether user consent is necessary is set so as to automatically execute the update work. In addition, some of the functions of the vehicle 10 that are restricted at the time of updating the software are easily acceptable to the user. For example, even if the entertainment function of HMI 16 is temporarily restricted, the user may be allowed to travel on the vehicles 10. Therefore, even when the function restriction occurs, whether user consent is necessary may be switched according to the restriction content.

Software updates may take a long time to perform an update operation or may be short. If the function of the vehicle 10 is limited during the update, the time for which the function is limited also increases as the working time increases. It is conceivable to set whether user consent is necessary in consideration of the time of the update operation. Software in this case is classified into one having a long update operation and one having a short update operation. When the time it takes to perform the update operation is long, user consent is obtained and then the update operation is executed, while when the time is short, whether user consent is necessary is set so as to automatically execute the update operation.

### OTHER EMBODIMENTS

### User Setting of Necessity of Consent

In the above embodiment, the OTA master 11 determines whether user consent is necessary based on a data table stored in advance in the storage device 13. The user may manually set whether user consent is necessary for each phase for each type of software.

FIG. 5 shows an exemplary configuration of a setting window displayed on HMI 16 for manual setting. The configuration example of the setting screen is configured such that the user can manually switch whether user consent is necessary for each phase for each type of software.

The type of software requiring user consent and the type of software not requiring user consent may be learned based on the selection result of the user, for example, as follows. Immediately after the learning is started, when the OTA master 11 receives the campaign information, it displays the following selection screen on HMI 16. The content of the update, a button for the user to select whether user consent is necessary for each phase, etc. are displayed on the selection screen. The OTA master 11 determines whether user consent is necessary for each phase of the current software update according to the user's selection results on the selection screen. The OTA master 11 stores the selection result of the user on the selection screen together with the type of the corresponding software. In this way, the OTA master 11 learns whether user consent is necessary for each type of software. When the software updates are repeated and the learning is completed, the OTA master 11 omits displaying of the selection screen and determines whether user consent is necessary based on the learning results.

Further, the above-described embodiments can be modified as follows. The present embodiment and the following modifications can be combined with each other within a technically consistent range to be realized. In the above embodiment, the OTA master 11 separately determines whether user consent is necessary for each of the download, installation, and activation phases. The necessity determination of each phase may be performed collectively. In other words, the OTA master 11 determines whether user consent is necessary for each phase after the campaign information is received, and records the determination result. In each phase, the OTA master 11 determines whether user consent is necessary based on the recorded determination results.

OTA master 11 of the above-described embodiment determines whether user consent is necessary for each of download, installation, and activation. The time to determine whether user consent is necessary in the process of updating the software and the number of times this determination is made may be changed.

The in-vehicle device of the above-described embodiment may be configured such that the authorization screen as illustrated in FIG. 4 is displayed on HMI 33 of the mobile terminal 30 of the user, and the user performs the authorization operation in HMI 33.

A different piece of in-vehicle equipment may perform either or both of the following operations performed by the OTA master 11 of the above embodiment: determining as to whether user consent is necessary, and making an inquiry to obtain user consent. For example, target equipment for the software update may perform at least one of the determination and the inquiry. In this case, the in-vehicle equipment that performs the determination corresponds to the determination unit, and the in-vehicle equipment that performs the inquiry corresponds to the control unit. As in the case where the determination unit and the control unit are different pieces of in-vehicle equipment, the in-vehicle device of the above embodiment may be composed of a plurality of pieces of in-vehicle equipment.

What is claimed is:

1. An in-vehicle device mounted on a vehicle and configured to manage an update of software for the vehicle, the in-vehicle device comprising:
a determination unit configured to determine whether user consent is necessary based on a type of the software; and
a control unit configured to, when the determination unit determines that the user consent is necessary, make an inquiry to a user as to whether to perform a process for the update of the software.

2. The in-vehicle device according to claim 1, wherein:
the update of the software is performed through the following three phases: downloading update data, installing an update program to in-vehicle equipment for which the update is to be performed, and activating the update program; and
the determination unit is configured to separately determine whether the user consent is necessary for execution of each of the three phases.

3. The in-vehicle device according to claim 1, wherein the user is allowed to select the type of the software that is to be determined by the determination unit to be a type for which the user consent is necessary, and the type of the software that is to be determined by the determination unit to be a type for which the user consent is not necessary.

4. The in-vehicle device according to claim 1, wherein the control unit is configured to make the inquiry through a human-machine interface mounted on the vehicle.

5. The in-vehicle device according to claim 1, wherein the control unit is configured to make the inquiry through a mobile terminal of the user.
